(19) United States
(12) Patent Application Publication
(10) Pub. No.: US 2025/0181499 A1
(43) Pub. Date: Jun. 5, 2025

(54) MEMORY MAPPING SYSTEM FOR REDUCING DATA RETRIEVAL COST IN STORAGE CONSISTING OF MULTIPLE MEMORIES

(71) Applicants: INDUSTRY ACADEMIA COOPERATION GROUP OF BAEKSEOK UNIVERSITY, Cheonan-si (KR); HOSEO UNIVERSITY ACADEMIC COOPERATION FOUNDATION, Asan-si (KR)

(72) Inventors: Hyun-Seob LEE, Cheonan-si (KR); Youngkyu HWANG, Asan-si (KR); Jung Soo HAN, Cheonan-si (KR)

(73) Assignees: INDUSTRY ACADEMIA COOPERATION GROUP OF BAEKSEOK UNIVERSITY, Cheonan-si (KR); HOSEO UNIVERSITY ACADEMIC COOPERATION FOUNDATION, Asan-si (KR)

(21) Appl. No.: 18/942,321

(22) Filed: Nov. 8, 2024

(30) Foreign Application Priority Data
Dec. 1, 2023 (KR) 10-2023-0172008

(51) Int. Cl. G06F 12/02

(52) U.S. Cl. CPC G06F 12/0246; G06F 2212/7201

(57) ABSTRACT

Proposed is a memory mapping system for reducing data retrieval cost in a storage consisting of multiple memories in order to manage data efficiently in the storage consisting of the various memories for data management. The memory mapping system includes the storage consisting of different types of the multiple memories, and a mapping table configured to map the memories of the storage, wherein the mapping table is configured to first map memory chips having respective absolute addresses and memory regions managed by the chips, and mapping information is linked to an upper bit of the memory mapping table. Accordingly, address schemes of data can be united, and retrieval cost for data divided and stored in different memories for data tiering can be reduced.

### CROSS REFERENCE TO RELATED APPLICATION

The present application claims priority to Korean Patent Application No. 10-2023-0172008, filed Dec. 1, 2023, the entire contents of which is incorporated herein for all purposes by this reference.

### BACKGROUND OF THE INVENTION

### Field of the Invention

The present disclosure relates to a memory mapping system. More particularly, the present disclosure relates to a memory mapping system for reducing data retrieval cost in a storage consisting of multiple memories in order to manage data efficiently in the storage consisting of the various memories for data management.

### Description of the Related Art

With the rapid advances in memory technology in recent years, different types of memories under development have been utilized to improve processing rate in data management systems.

In particular, a NAND flash memory has non-volatility that data is retained even when power is cut, so the NAND flash memory has been utilized as a main medium for data storage in a memory-based storage.

However, a recently researched memory-based storage consists of a NAND flash memory as well as various types of memories, such as MRAM and PRAM, and various types of memories with additional new characteristics are under development. Therefore, there is a need for research on memory management technology for improving data processing performance and efficiency of a medium in a storage system consisting of memories having different characteristics.

The foregoing is intended merely to aid in the understanding of the background of the present disclosure, and is not intended to mean that the present disclosure falls within the purview of the related art that is already known to those skilled in the art.

### Document of Related Art

(Patent Document 1) Korean Patent Application Publication No. 10-2017-0044782 (26 Apr. 2017)

### SUMMARY OF THE INVENTION

The present disclosure is directed to providing a memory mapping system for reducing data retrieval cost in a storage consisting of multiple memories, wherein memories different from each other are managed utilizing one mapping table.

According to an embodiment of the present disclosure, there is provided a memory mapping system for reducing data retrieval cost in a storage consisting of multiple memories, the memory mapping system including: the storage consisting of different types of the multiple memories; and a mapping table configured to map the memories of the storage, wherein the mapping table is configured to first map memory chips having respective absolute addresses and memory regions managed by the chips, and mapping information is linked to an upper bit of the memory mapping table.

Preferably, the mapping table may be configured to perform first mapping between the chips in the storage, and use mapped IDs to distinguish the mapping information of the memories, and each of the IDs may be converted to a binary number and the binary number may be applied to the upper bit not used in a physical address of the mapping table.

In addition, the storage may be consisting of different types of a first memory and a second memory, data d, e, f, g, h, and i may be stored at addresses 0, 1, 2, 3, 4, and 5 of the second memory, the first memory may be loaded with data a, b, c, d, e, and f, and the data d, e, and f may be duplicate data that are maintained as the latest data in the first memory.

According to the present disclosure, address schemes of data can be united, and retrieval cost for data divided and stored in different memories for data tiering can be reduced.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram illustrating block mapping of a memory mapping system for reducing data retrieval cost in a storage consisting of multiple memories according to an embodiment of the present disclosure;

FIG. 2 is a diagram illustrating page mapping of a memory mapping system for reducing data retrieval cost in a storage consisting of multiple memories according to an embodiment of the present disclosure;

FIG. 3 is a diagram illustrating a structure of a storage consisting of a DRAM and a NAND flash memory, which has an independent management scheme of a memory mapping system for reducing data retrieval cost in a storage consisting of multiple memories according to an embodiment of the present disclosure;

FIG. 4 is a diagram illustrating the key idea of memory mapping of a memory mapping system for reducing data retrieval cost in a storage consisting of multiple memories according to an embodiment of the present disclosure;

FIG. 5 is a diagram illustrating a simple example of a memory map used in a memory-based storage of a memory mapping system for reducing data retrieval cost in a storage consisting of multiple memories according to an embodiment of the present disclosure;

FIG. 6 is a diagram illustrating, in a storage in which 64 KB of memories different from each other configured at addresses 0x10000000 and 0x20000000, a method of performing first mapping between chips and using mapped IDs to distinguish mapping information of the memories, in a memory mapping system for reducing data retrieval cost in a storage consisting of multiple memories according to an embodiment of the present disclosure;

FIG. 7 is a diagram illustrating an example of applying a memory mapping method in a storage system consisting of a DRAM buffer and a NAND flash memory having different characteristics, in a memory mapping system for reducing data retrieval cost in a storage consisting of multiple memories according to an embodiment of the present disclosure;

FIG. 8 is a diagram illustrating the number of hits occurred when trace data was managed with LRU by increasing a buffer from 128 KB to 1 MB, in a memory mapping system for reducing data retrieval cost in a storage consisting of multiple memories according to an embodiment of the present disclosure;

FIG. 9 is a diagram illustrating a result of analyzing retrieval cost occurred when hit data and non-hit data were retrieved from a buffer, in a memory mapping system for reducing data retrieval cost in a storage consisting of multiple memories according to an embodiment of the present disclosure; and

FIG. 10 is a diagram illustrating differences in retrieval performance occurred from comparison between a mapping technique and sequential retrieval, in a memory mapping system for reducing data retrieval cost in a storage consisting of multiple memories according to an embodiment of the present disclosure.

### DETAILED DESCRIPTION OF THE INVENTION

Hereinbelow, an exemplary embodiment of the present disclosure will be described in detail with reference to the accompanying drawings. Throughout the drawings, the same reference numerals will refer to the same or like parts.

A memory mapping system for reducing data retrieval cost in a storage consisting of multiple memories according to an embodiment of the present disclosure proposes a memory mapping technique for managing data efficiently in a storage consisting of various memories for data management.

In the present embodiment, the proposed idea is a method of managing memories different from each other by utilizing one mapping table. This method unites address schemes of data to manage the data efficiently.

For reference, a chip structure of a NAND flash memory used as a main medium consists of several blocks, and each of the blocks includes several pages. However, compared to a storage medium, reading/writing is processed on a per-page basis, while erasing is processed on a per-block basis. Therefore, if this characteristic is not considered, various problems, such as erratic performance degradation, may occur. The flash transfer layer (FTL), which is applied to solve these problems, utilizes mapping technique to hide the characteristics of the NAND flash memory.

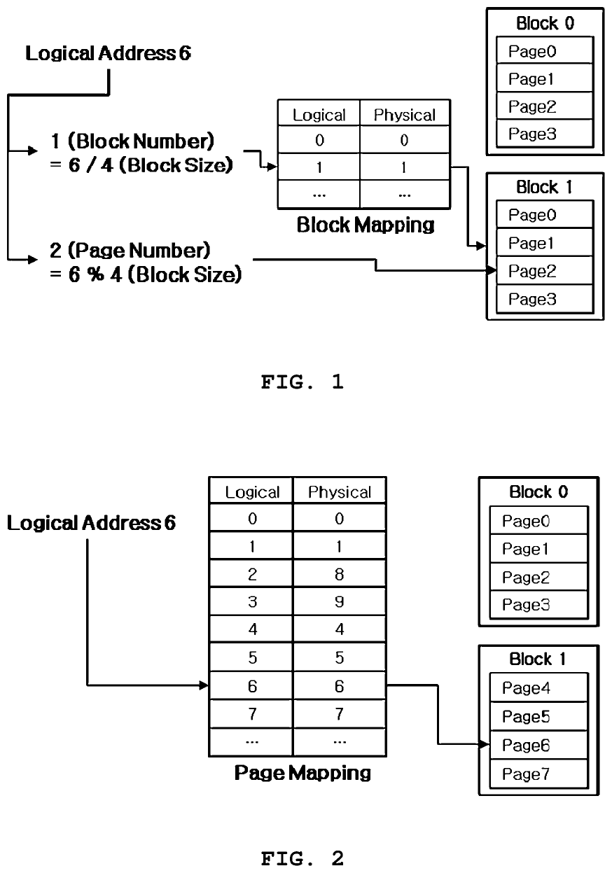

FIG. 1 is a diagram illustrating block mapping of a memory mapping system for reducing data retrieval cost in a storage consisting of multiple memories according to an embodiment of the present disclosure. As shown in FIG. 1, block mapping maps logical addresses and physical addresses on a per-block basis. In addition, an address of a logical block is identified through the quotient resulting from division by a block size, and the position of a page within a block is identified through an offset result of a mod operation with a block size.

It can be seen that the logical block number of logical address 6 is 1 resulting from a division operation by block size 4. In addition, logical block 1 is mapped to physical block 1. Then, it can be seen that the page offset within the block is 2 through an operation. The block mapping method converts a logical address to a physical address and thus hides the characteristics of the NAND flash memory, but an additional operation needs to be performed to access a page in which data is stored.

FIG. 2 is a diagram illustrating page mapping of a memory mapping system for reducing data retrieval cost in a storage consisting of multiple memories according to an embodiment of the present disclosure. FIG. 2 shows page mapping.

Page mapping maps physical page addresses for all logical addresses. In FIG. 2, it can be seen that logical address 6 is mapped to physical page 6. Therefore, rapid access to a mapped page is allowed without any additional operation. However, page mapping may consume a lot of memory resources because all page mapping information should be maintained.

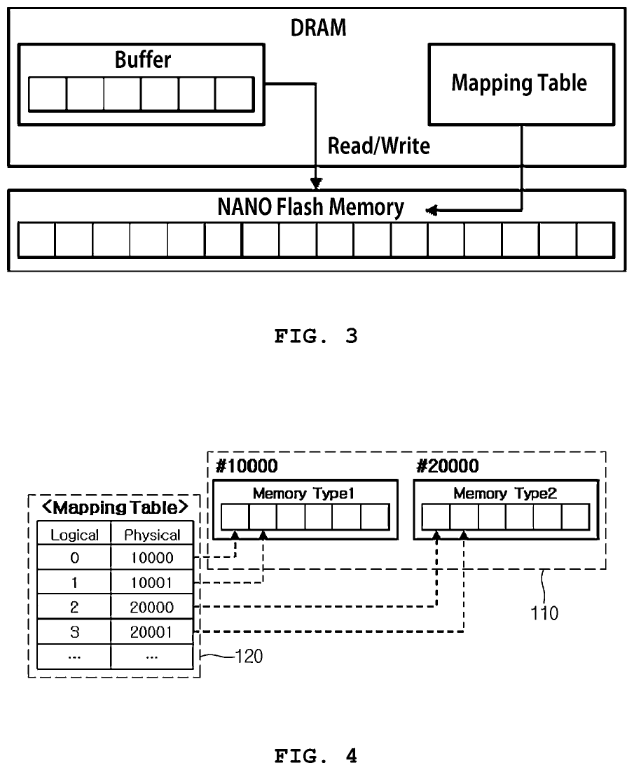

FIG. 3 is a diagram illustrating a structure of a storage consisting of a DRAM and a NAND flash memory, which has an independent management scheme of a memory mapping system for reducing data retrieval cost in a storage consisting of multiple memories according to an embodiment of the present disclosure.

In FIG. 3, data of a user is managed in the NAND flash memory. In addition, the DRAM maintains a buffer and a mapping table of the FTL to overcome the transmission rate between the NAND flash memory and a host.

As shown in the example in FIG. 3, the NAND flash memory is utilized as a large-capacity storage medium because of its non-volatility and good price to capacity. In a large-capacity storage, the mapping table of the FTL has been widely utilized for data retrieval. On the other hand, the DRAM having volatility and rapid data access rate uses a buffer space to maintain a small amount of data, so data is retrieved through sequential retrieval without a separate management scheme for retrieval. In current storage designs, retrieval from a small amount of high-speed memory is not costly, but in a technology advance environment where a memory diversify, when a new type of large-capacity memory is applied, sequential retrieval from a memory without a separate management scheme increases inefficiency. In addition, adding a separate management scheme to improve retrieval rate may increase cost.

FIG. 4 is a diagram illustrating the key idea of memory mapping of a memory mapping system for reducing data retrieval cost in a storage consisting of multiple memories according to an embodiment of the present disclosure.

A memory mapping system for reducing data retrieval cost in a storage consisting of multiple memories according to the present embodiment includes: a storage 110 consisting of memories different from each other; and a mapping table 120 configured to map the memories of the storage with the one mapping table.

As shown in FIG. 4, a technique for mapping memories using one mapping table in a storage consisting of different types of multiple memories will be described. This technique can reduce retrieval cost when memories having a difference in rate are utilized as buffers.

FIG. 4 shows the proposed key idea. Two chips of memory types different from each other are positioned at addresses 10000 and 20000. In addition, each memory is mapped without distinction in one mapping table.

For example, data at logical addresses 0 and 1 are mapped to addresses 10000 and 10001 of memory type 1.

In addition, data at logical addresses 2 and 3 are mapped to addresses 20001 and 20001 of memory type 2.

This method unifies and simplifies memory management in a storage consisting of multiple memories.

A memory type identification policy of a memory mapping system for reducing data retrieval cost in a storage consisting of multiple memories according to an embodiment of the present disclosure will be described as follows.

The method proposed in the present embodiment is to manage memories different from each other in one mapping table. However, the memories have different characteristics, so a memory type identification method is required to distinguish and manage the memories.

In the present embodiment, a policy of distinguishing memories on the basis of addresses will be described.

FIG. 5 is a diagram illustrating a simple example of a memory map used in a memory-based storage of a memory mapping system for reducing data retrieval cost in a storage consisting of multiple memories according to an embodiment of the present disclosure.

Each module of the storage is connected with an advanced extensible interface (AXI) bus in the center. In addition, each module has a unique absolute address for identification in the bus.

*34 However, a relative address of each module starts at address 0, regardless of the absolute address.

For example, blocks and pages of each memory chip start at page 0 of block 0. In addition, in general, a mapping table that manages a single memory identifies addresses of blocks and page numbers and performs mapping according to the relative order in which a memory chip is connected.

The address scheme of the mapping table causes confusion in identifying each memory type and chip when various memory chips having different absolute addresses are mapped.

Therefore, designed is a technique that first maps memory chips having respective absolute addresses and memory regions managed by the chips, and links the mapping information to an upper bit of the memory mapping table.

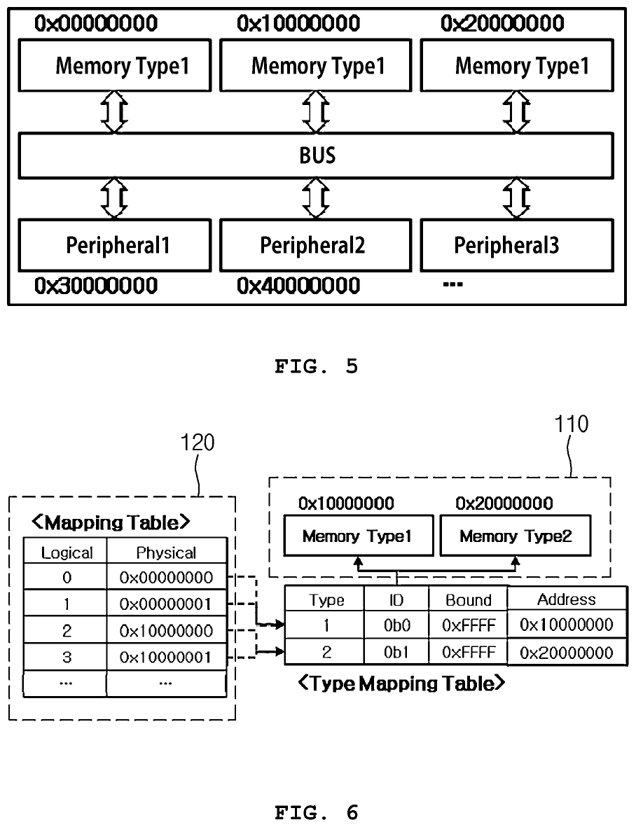

FIG. 6 is a diagram illustrating, in a storage in which 64 KB of memories different from each other configured at addresses 0x10000000 and 0x20000000, a method of performing first mapping between chips and using mapped IDs to distinguish mapping information of the memories, in a memory mapping system for reducing data retrieval cost in a storage consisting of multiple memories according to an embodiment of the present disclosure.

A memory mapping system for reducing data retrieval cost in a storage consisting of multiple memories according to the present embodiment includes: a storage 110 consisting of memories different from each other; and a mapping table 120 configured to map the memories of the storage with the one mapping table. The mapping table first maps memory chips having respective absolute addresses and memory regions managed by the chips, and links mapping information to an upper bit of the memory mapping table.

In the example in FIG. 6, in first mapping, memory type 1 at address 0x10000000 is mapped to ID 0 and memory type 2 at address 0x20000000 is mapped to ID 1. In addition, each ID is converted to a binary number and the binary number is applied to an upper bit not used in the physical addresses of the mapping table.

For example, this means that logical address 0 and page 1 are mapped to physical address 0 and page 1 of memory type 1 and logical address 2 and page 3 are mapped to physical address 0 and page 1 of memory type 2.

Application for improving buffer retrieval rate in a memory mapping system for reducing data retrieval cost in a storage consisting of multiple memories according to an embodiment of the present disclosure will be described as follows.

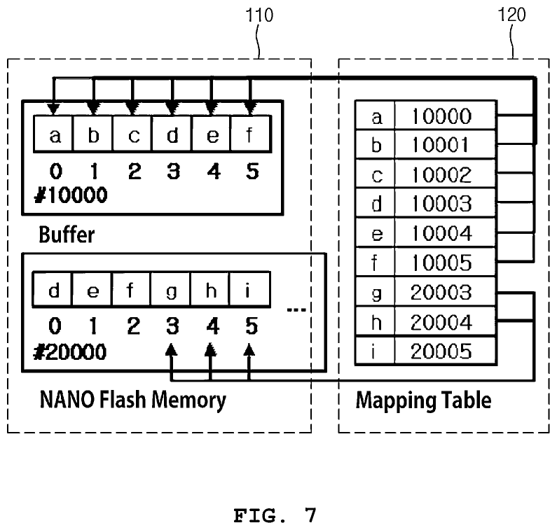

FIG. 7 is a diagram illustrating an example of applying a memory mapping method in a storage system consisting of a DRAM buffer (a first memory) and a NAND flash memory (a second memory) having different characteristics, in a memory mapping system for reducing data retrieval cost in a storage consisting of multiple memories according to an embodiment of the present disclosure.

In FIG. 7, data d, e, f, g, h, and i are stored at addresses 0, 1, 2, 3, 4, 5 of the NAND flash memory, which is the second memory. In addition, data a, b, c, d, e, and f are loaded at the DRAM buffer, which is the first memory. Among them, data d, e, and f are duplicate data that are maintained as the latest data in the DRAM buffer, which is the first memory.

If there is no separate scheme for managing a buffer, the buffer uses sequential retrieval to find data.

That is, retrieval is required 4, 5, and 6 times to find data d, e, and f, respectively. In addition, if a separate management scheme is added to improve retrieval performance, additional cost is required. However, the proposed idea is that the mapping table for managing the NAND flash memory may further manage the buffer, so that an address scheme capable of identifying different types of memories can be maintained without overhead and retrieval cost of the buffer can be reduced.

Regarding a memory mapping system for reducing data retrieval cost in a storage consisting of multiple memories mentioned in the present embodiment, an experiment showed that the proposed idea can reduce retrieval cost of the DRAM buffer.

The present embodiment proposes a method of managing memories by using one mapping table. To analyse the benefits of applying the proposed idea to a buffer management policy, experiment evaluation was made through simulation. The simulation experiment measured and analyzed the number of times that the buffer was accessed and reading performance that occurred when about 1 million pieces of trace data were managed with least recently used (LRU) by increasing the size of the buffer from 128 KB to 1 MB.

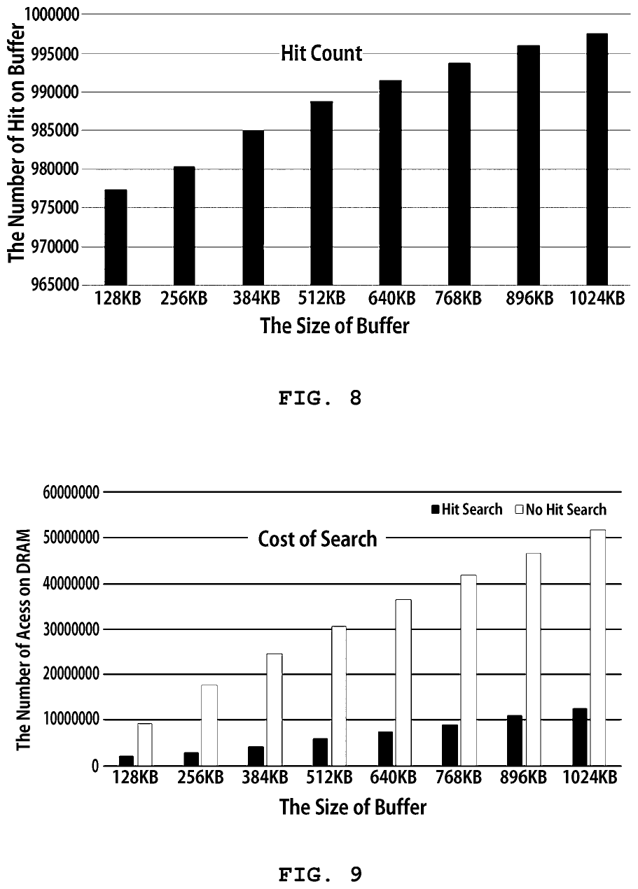

FIG. 8 is a diagram illustrating the number of hits occurred when trace data was managed with LRU by increasing a buffer from 128 KB to 1 MB, in a memory mapping system for reducing data retrieval cost in a storage consisting of multiple memories according to an embodiment of the present disclosure.

It can be seen that as the size of the buffer increased, the number of pieces of loadable data increased and the number of hits increased overall, specifically, 977, 391 hits at 128 KB and 997, 586 hits at 1 M.

FIG. 9 is a diagram illustrating a result of analyzing retrieval cost occurred when hit data and non-hit data were retrieved from a buffer, in a memory mapping system for reducing data retrieval cost in a storage consisting of multiple memories according to an embodiment of the present disclosure.

Overall, the cost of retrieving non-hit data from the buffer was about 75˜ 84% higher than the cost of retrieving hit data. At 128 KB, 2,158,303 and 9,174,609 memory accesses were attempted, and at 1 M, 12,456,804 and 51,739,950 accesses were attempted.

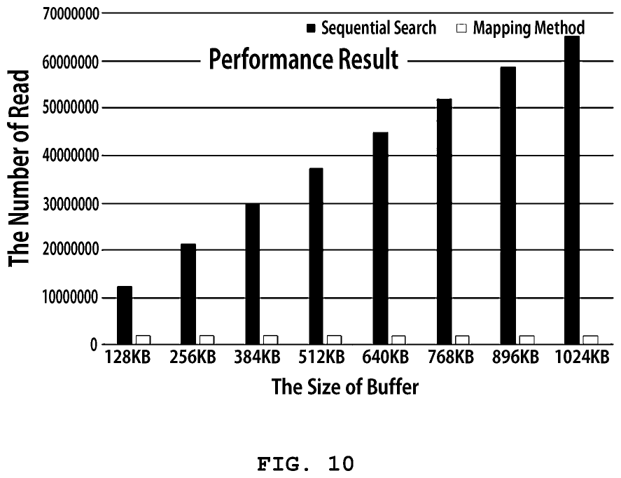

FIG. 10 is a diagram illustrating differences in retrieval performance occurred from comparison between a mapping technique and sequential retrieval, in a memory mapping system for reducing data retrieval cost in a storage consisting of multiple memories according to an embodiment of the present disclosure.

As shown in the result in FIG. 10, the mapping technique showed constant performance, while the sequential retrieval technique showed that the retrieval cost increased as the size of the buffer increased. Overall, the performance difference was about 92˜98%, and the mapping technique had performance improvement of 92.06% at 128 KB and 98.46% at 1 MB.

The present embodiment proposes a memory mapping technique for managing data efficiently in a storage consisting of various memories for data management. The proposed idea is a method of managing memories different from each other by utilizing one mapping table. This method unites address schemes of data to manage the data efficiently without additional resources.

In addition, the experiment showed that retrieval cost for stored data can be reduced by about 90% or more when different memories are divided and managed as a buffer and a storage medium. The proposed method is to apply various types of memories to manage the memories efficiently in next-generation storages under research.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims.

What is claimed is:

1. A system for mapping a storage (110) consisting of two or more different types of memories, the system comprising:
a mapping table (120) configured to map of the storage,
wherein the mapping table is configured to map the types of memories and absolute addresses in a respective memory.

2. The system of claim 1,
wherein upper bits of a mapping information are used to mapping the types of memories, and the remaining bits are used to mapping the absolute addresses in a respective memory.

3. The system of claim 1, wherein the storage is consisting of different types of a first memory and a second memory,
data d, e, f, g, h, and i are stored at addresses 0, 1, 2, 3, 4, and 5 of the second memory, and
the first memory is loaded with data a, b, c, d, e, and f, and the data d, e, and f are duplicate data that are maintained as the latest data in the first memory.
